(19) United States
(12) Patent Application Publication
(10) Pub. No.: US 2022/0035189 A1
(43) Pub. Date: Feb. 3, 2022

(54) DISPLAY DEVICE

(71) Applicant: Japan Display Inc., Tokyo (JP)

(72) Inventors: Genki ASOZU, Tokyo (JP); Toshiyuki HIGANO, Tokyo (JP); Hirohisa MIKI, Tokyo (JP)

(21) Appl. No.: 17/501,423

(22) Filed: Oct. 14, 2021

Related U.S. Application Data
(63) Continuation of application No. PCT/JP2020/001052, filed on Jan. 15, 2020.

(30) Foreign Application Priority Data
Apr. 16, 2019 (JP) 2019-077910

(51) Int. Cl. G02F 1/1334

(52) U.S. Cl. CPC G02F 1/1334

(57) ABSTRACT

According to one embodiment, a display device includes a plurality of first prisms, a plurality of second prisms and a display panel provided between the first prisms and the second prisms, and the display panel includes a first substrate including a first transparent substrate and a pixel electrode, a second substrate including a second transparent substrate and a common electrode opposing the pixel electrode, and a liquid crystal layer provided between the first substrate and the second substrate and containing a polymer and liquid crystal molecules.

### CROSS-REFERENCE TO RELATED APPLICATIONS

This application is a Continuation Application of PCT Application No. PCT/JP2020/001052, filed Jan. 15, 2020 and based upon and claiming the benefit of priority from Japanese Patent Application No. 2019-077910, filed Apr. 16, 2019, the entire contents of all of which are incorporated herein by reference.

### FIELD

Embodiments described herein relate generally to a display device.

### BACKGROUND

In recent years, various display devices comprising a polymer-dispersed liquid crystal layer have been proposed. For example, a head-up display comprising a polymer-dispersed liquid crystal layer and a liquid crystal layer between an electrode substrate and a transparent angle layer has been disclosed. According to this technology, when no voltage is applied, light entering from the outer surface is refracted at the interface between the transparent angle layer and the liquid crystal layer, and is scattered by the polymer-dispersed liquid crystal layer. On the other hand, when voltage is applied, the entering light from the outer surface is not refract, but travels straight through the transparent angle layer, the liquid crystal layer, and the polymer-dispersed liquid crystal layer.

### SUMMARY

The present disclosure relates generally to a display device.

According to an embodiment, a display device includes a plurality of first prisms, a plurality of second prisms and a display panel provided between the first prisms and the second prisms, and the display panel includes a first substrate including a first transparent substrate and a pixel electrode, a second substrate including a second transparent substrate and a common electrode opposing the pixel electrode, and a liquid crystal layer provided between the first substrate and the second substrate and containing a polymer and liquid crystal molecules.

### BRIEF DESCRIPTION OF THE DRAWINGS

FIG. 1 is a plan view showing a configuration example of a display device DSP according to an embodiment.

FIG. 2 is a cross-sectional view showing a configuration example of a display panel PNL shown in FIG. 1.

FIG. 3 is a cross-sectional view showing the first configuration example of the display device DSP of this embodiment.

FIG. 4A is a diagram which illustrates a transparent state of the display panel PNL.

FIG. 4B is a diagram which illustrates a scattered state of the display panel PNL.

FIG. 4C is a diagram showing an example of luminance distribution of the display panel PNL in the scattered state.

FIG. 5 is a diagram which illustrates the transparent state in the display device DSP of this embodiment.

FIG. 6 is a diagram which illustrates the scattered state in the display device DSP of this embodiment.

FIG. 7 is a diagram showing an example which illustrates an optimum angle of a second apical angle θ2.

FIG. 8A is a diagram showing another example which illustrates the optimal angle of the second apical angle θ2.

FIG. 8B is a diagram showing still another example which illustrates the optimal angle of the second apical angle θ2.

FIG. 9 is a diagram showing a configuration example of a first prism P1 and a second prism P2.

FIG. 10 is a diagram showing another configuration example of the first prism P1 and the second prism P2.

FIG. 11 is a cross-sectional view of a second configuration example of the display device DSP of this embodiment.

FIG. 12 is a cross-sectional view showing a third configuration example of the display device DSP.

### DETAILED DESCRIPTION

In general, according to one embodiment, a display device includes a plurality of first prisms, a plurality of second prisms and a display panel provided between the first prisms and the second prisms, and the display panel includes a first substrate comprising a first transparent substrate and a pixel electrode, a second substrate comprising a second transparent substrate and a common electrode opposing the pixel electrode, and a liquid crystal layer provided between the first substrate and the second substrate and containing a polymer and liquid crystal molecules.

According to the present embodiments, a display device which can reduce power consumption can be provided.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same elements as those described in connection with preceding drawings are denoted by like reference numerals, and a detailed description thereof is omitted unless otherwise necessary.

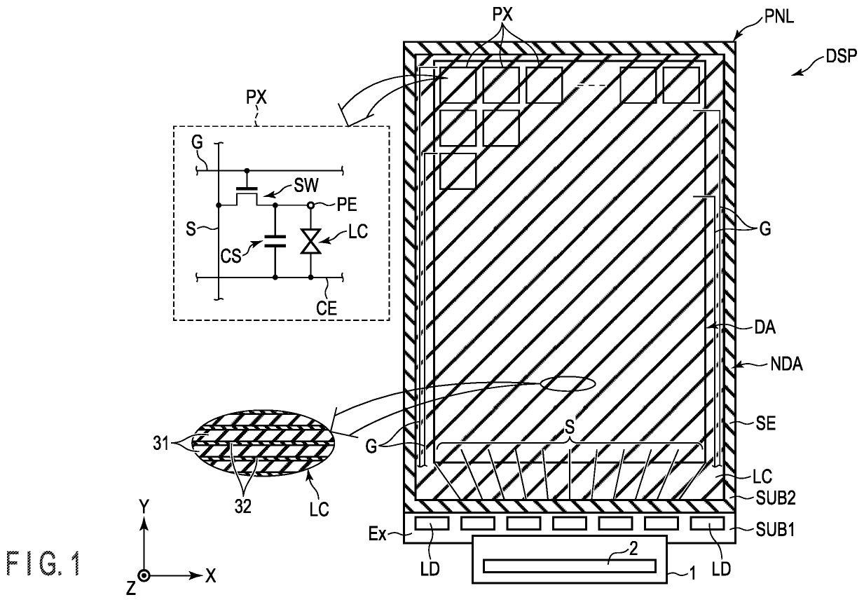

FIG. 1 is a plan view showing a configuration example of the display device DSP of one embodiment. For example, a first direction X, a second direction Y and a third direction Z are orthogonal to each other, but may intersect at an angle other than ninety degrees. The first direction X and the second direction Y correspond to directions parallel to a main surface of a substrate which constitutes the display device DSP, and the third direction Z corresponds to a thickness direction of the display device DSP.

When assumed that an observation position for observing the display device DSP is located at a tip side of the arrow indicating the third direction Z, a view from this observation position toward the X-Y plane defined by the first direction X and the second direction Y is called plan view.

In this embodiment, as an example of the display device DSP, a liquid crystal display device to which a polymer-dispersed liquid crystal is applied will be described. The display device DSP comprises a display panel PNL, a wiring substrate 1, an IC chip 2 and a light-emitting element LD.

The display panel PNL comprises a first substrate SUB1, a second substrate SUB2, a liquid crystal layer LC and a sealant SE. The first substrate SUB1 and the second substrate SUB2 are formed into a flat plate shape which is parallel to the X-Y plane. The first substrate SUB1 and the second substrate SUB2 are overlaid on each other in plan view. The first substrate SUB1 and the second substrate SUB2 are attached to each other by the sealant SE. The liquid crystal layer LC is held between the first substrate SUB1 and the second substrate SUB2, and is sealed by the sealant SE. In FIG. 1, the liquid crystal layer LC and the sealant SE are respectively indicated by different hatch lines.

As enlarged and schematically shown in FIG. 1, the liquid crystal layer LC comprises a polymer-dispersed liquid crystal containing a polymer 31 and liquid crystal molecules 32. For example, the polymer 31 is a liquid crystalline polymer. The polymer 31 is formed into a strip shape extending along the first direction X. The liquid crystal molecules 32 are dispersed in the spaces in the polymer 31 so that their longitudinal axes are aligned along the first direction X. Each of the polymer 31 and liquid crystal molecules 32 has optical anisotropy or refractive index anisotropy. The responsiveness of the polymer 31 to electric fields is lower than that of the liquid crystal molecules 32 to electric fields.

For example, the alignment direction of the polymer 31 does not substantially vary regardless of the presence or absence of an electric field. On the other hand, the alignment direction of the liquid crystal molecules 32 varies in response to the electric field when a voltage higher than the threshold is applied to the liquid crystal layer LC. While no voltage is being applied to the liquid crystal layer LC, the optical axes of the polymer 31 and liquid crystal molecules 32 are parallel to each other, and light entering the liquid crystal layer LC is not substantially scattered in the liquid crystal layer LC and transmitted therethrough (transparent state). When a voltage is applied to the liquid crystal layer LC, the optical axes of the polymer 31 and liquid crystal molecules 32 cross each other, and light entering the liquid crystal layer LC is scattered in the liquid crystal layer LC (scattered state).

The display panel PNL comprises a display area DA that displays images, and a frame-shaped non-display area NDA that surrounds the display area DA. The sealant SE is provided in the non-display area NDA. The display area DA comprises pixels PX arranged in a matrix along the first direction X and the second direction Y.

As enlargedly shown in FIG. 1, each pixel PX comprises a switching element SW, a pixel electrode PE, a common electrode CE, a liquid crystal layer LC and the like. The switching element SW is constituted, for example, by a thin-film transistor (TFT) and is electrically connected to a respective scanning line G and a respective signal line S. The scanning line G is electrically connected to the switching elements SW of the pixels PX arranged in the first direction X. The signal line S is electrically connected to the switching elements SW of the pixels PX arranged in the second direction Y. The pixel electrode PE is electrically connected to the switching element SW. The common electrode CE is commonly provided for a plurality of pixel electrodes PE. Each of the pixel electrodes PE opposes the respective common electrode CE in the third direction Z. The liquid crystal layer LC (particularly, the liquid crystal molecules 32) is driven by the electric field generated between the pixel electrode PE and the common electrode CE. The capacitance CS is formed, for example, between an electrode of the same potential as that of the common electrode CE and an electrode of the same potential as that of the respective pixel electrode PE.

As will be explained later, the scanning lines G, the signal lines S, the switching elements SW and the pixel electrodes PE are provided on the first substrate SUB1, and the common electrodes CE are provided on the second substrate SUB2. In the first substrate SUB1, the scanning lines G and the signal lines S are electrically connected to the wiring substrate 1 or the IC chip 2.

The wiring substrate 1 is electrically connected to an extended portion Ex of the first substrate SUB1. The wiring substrate 1 is a flexible printed circuit board which can be bent. The IC chip 2 is electrically connected to the wiring substrate 1. The IC chip 2 incorporates, for example, a display driver that outputs signals necessary for image display. Note that the IC chip 2 may be electrically connected to the extended portion Ex.

The light-emitting elements LD are superimposed on the extended portion Ex in plan view. The light-emitting elements LD are arranged with intervals therebetween along the first direction X.

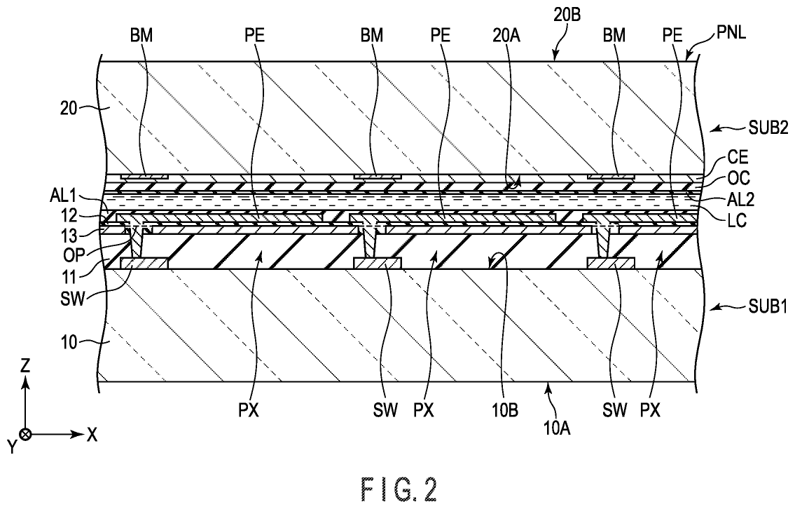

FIG. 2 is a cross-sectional view showing a configuration example of the display panel PNL shown in FIG. 1.

The first substrate SUB1 comprises a first transparent substrate 10, insulating films 11 and 12, a capacitive electrode 13, switching elements SW, pixel electrodes PE, and an alignment film AL1. The first transparent substrate 10 comprises a main surface (lower surface) 10A and a main surface (upper surface) 10B on the opposite side to the main surface 10A. The switching elements SW are disposed on the main surface 10B. The insulating film 11 covers the switching elements SW. The scanning lines G and the signal lines S shown in FIG. 1 are disposed between the first transparent substrate 10 and the insulating film 11, but here they are omitted from the illustration. The capacitive electrode 13 is disposed between the insulating films 11 and 12. The pixel electrodes PE are disposed between the insulating film 12 and the alignment film AL1 for the respective pixels PX. The pixel electrodes PE are electrically connected to the respective switching elements SW through openings OP of the capacitive electrode 13. The pixel electrodes PE overlap the capacitive electrode 13 across the insulating film 12, thus forming the capacitance CS of each pixel PX. The alignment film AL1 covers the pixel electrodes PE.

The second substrate SUB2 comprises a second transparent substrate 20, light-shielding layers BM, a common electrode CE, an overcoat layer OC and an alignment film AL2. The second transparent substrate 20 comprises a main surface (lower surface) 20A and a main surface (upper surface) 20B on the opposite side to the main surface 20A. The main surface 20A of the second transparent substrate 20 opposes the main surface 10B of the first transparent substrate 10. The light-shielding layers BM and the common electrode CE are disposed on a main surface 20A side. For example, the light-shielding layers BM are disposed directly above the respective switching elements SW and directly above the respective scanning lines G and the respective signal lines S, which are not shown in the figure. The common electrode CE is disposed over a plurality of pixels PX and opposes a plurality of pixel electrodes PE in the third direction Z. Further, the common electrode CE covers the light-shielding layers BM. The common electrode CE is electrically connected to the capacitive electrode 13 and is at the same potential as that of the capacitive electrode 13. The overcoat layer OC covers the common electrode CE. The alignment film AL2 covers the overcoat layer OC.

The liquid crystal layer LC is provided between the first substrate SUB1 and the second substrate SUB2, and is in contact with the alignment films AL1 and AL2.

The first transparent substrate 10 and the second transparent substrate 20 are insulating substrates such as of glass substrates or plastic substrates. The insulating film 11 is formed of a transparent insulating material such as silicon oxide, silicon nitride, silicon oxynitride, acrylic resin or the like. For example, the insulating film 11 includes an inorganic insulating film and an organic insulating film. The insulating film 12 is an inorganic insulating film such as of silicon nitride. The capacitive electrode 13, the pixel electrodes PE, and the common electrode CE are transparent electrodes formed of a transparent conductive material such as indium tin oxide (ITO) and indium zinc oxide (IZO). The light-shielding layers BM comprise a conductive layer with lower resistance than that of the common electrode CE, for example. For example, the light-shielding layers BM are formed of an opaque metallic material such as molybdenum, aluminum, tungsten, titanium or silver. The common electrode CE is in contact with the light-shielding layers BM, and thus it is electrically connected to the light-shielding layers BM. With this configuration, the common electrode CE has low resistance. The alignment films AL1 and AL2 are horizontal alignment films having an alignment restriction force that is substantially parallel to the X-Y plane. For example, the alignment films AL1 and AL2 are subjected to alignment treatment along the first direction X. Note that the alignment treatment may be rubbing treatment or photo-alignment treatment.

### First Configuration Example

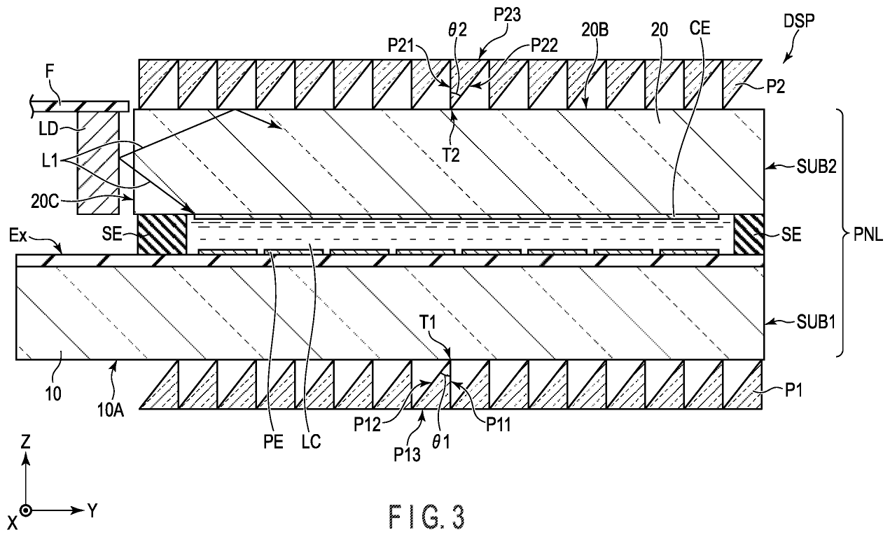

FIG. 3 is a cross-sectional view showing the first configuration example of the display device DSP of this embodiment. Note here that only the main parts of the display panel PNL is shown in the figure.

The second transparent substrate 20 comprises a side surface 20C opposing the light-emitting element LD in the second direction Y. The light-emitting element LD is electrically connected to the wiring substrate F. The light-emitting element LD is, for example, a light-emitting diode, and includes a red-emitting portion, a green-emitting portion and a blue-emitting portion, although they are not described in detail. Note that a transparent light guide may be disposed between the light-emitting element LD and the side surface 20C.

The display device DSP comprises first prisms P1 and second prisms P2. The display panel PNL is provided between the first prisms P1 and the second prisms P2. In the example illustrated in FIG. 3, the first prisms P1, the first transparent substrate 10, the liquid crystal layer LC, the second transparent substrate 20 and the second prisms P2 are arranged in this order along the third direction Z. The first prisms P1 are arranged along the second direction Y on the main surface 10A of the first transparent substrate 10. Similarly, the second prisms P2 are arranged along the second direction Y on the main surface 20B of the second transparent substrate 20.

The first prisms P1 each comprise a first apex T1, a first surface P11, a first inclined surface P12 and a first bottom surface P13. The first apexes T1 oppose the first transparent substrate 10 and are in contact with the main surface 10A. The space between each adjacent pair of first prisms P1 has a refractive index lower than that of the first transparent substrate 10 and that of the first prism P1. The space is, for example, an air layer. In other words, the main surface 10A is in contact with the air layer except for the areas in contact with the first apexes T1.

The first surfaces P11 are each a surface substantially perpendicular to the first transparent substrate 10 and each extend along the first direction X. In other words, the first surfaces P11 are each a surface substantially parallel to the X-Z plane defined by the first direction X and the third direction Z. The first inclined surfaces P12 are each a surface inclined with respect to the first transparent substrate 10 and extend along the first direction X. The first inclined surfaces P12 are each located on a side of the respective first prism P1, which is closer to the light-emitting element LD than the first surface P11. The first surface P11 and the first inclined surface P12 form the first apex T1. The first apex T1 has a first apical angle θ1. The first bottom surface P13 opposes the first apex T1 and is substantially parallel to the X-Y plane.

The second prisms P2 each comprise a second apex T2, a second surface P21, a second inclined surface P22 and a second bottom surface P23. The second apexes T2 oppose the second transparent substrate 20 and are in contact with the main surface 20B. The space between each adjacent pair of second prisms P2 has a lower refractive index than that of the second transparent substrate 20 and that of the second prism P2. The space is, for example, an air layer. In other words, the main surface 20B is in contact with the air layer except for the areas in contact with the second apexes T2.

The second surfaces P21 are each a surface substantially perpendicular to the second transparent substrate 20 and each extend along the first direction X. In other words, the second surfaces P21 are each a surface substantially parallel to the X-Z plane as in the case of the first surfaces P11. The second inclined surfaces P22 are each a surface inclined with respect to the second transparent substrate 20 and extend along the first direction X. The second inclined surfaces P22 are substantially parallel to the first inclined surfaces P12, respectively. The second inclined surfaces P22 are each located on a side of the respective second prism P2, that is farther from the light-emitting element LD than the second plane P21. The second surface P21 and the second inclined surface P22 form the second apex T2. The second apex T2 has a second apical angle θ2. The second apical angle θ2 is an angle equivalent to the first apical angle θ1. As will be discussed later, the first apical angle θ1 and the second apical angle θ2 are each greater than 15° but less than 21°. The second bottom surface P23 opposes the second apex T2 and is substantially parallel to the X-Y plane.

Next, with reference to FIG. 3, light L1 emitted from the light-emitting element LD will be described.

The light-emitting element LD emits light L1 toward the side surface 20C. The light L1 emitted from the light-emitting element LD travels along the direction of the arrow indicating the second direction Y and enters the transparent substrate 20 from the side surface 20C. The light L1 entering the transparent substrate 20 travels through inside the display panel PNL while being repeatedly reflected.

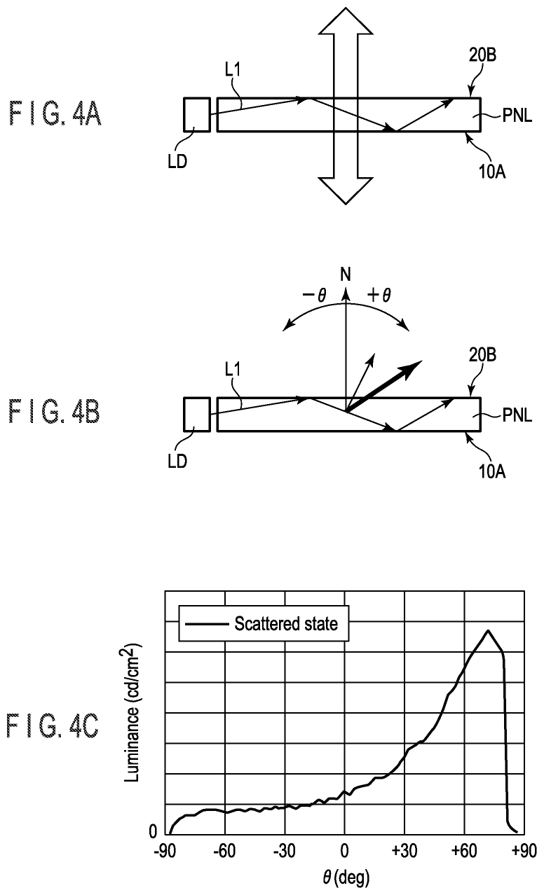

FIGS. 4A through 4C are diagrams illustrating the transparent state and the scattered state of the display panel PNL. Note that the display panel PNL is illustrated in a simplified form.

FIG. 4A is a diagram to explain the transparent state of the display panel PNL. As explained with reference to FIG. 1, when no voltage is applied to the liquid crystal layer LC, the light L1 entering the liquid crystal layer LC is transmitted through the liquid crystal layer LC without substantially scattered. At this time, the background of the display panel PNL can be observed through the display panel PNL regardless of whether the display panel PNL is observed from the main surface 10A side or from the main surface 20B side.

FIG. 4B is a diagram illustrating the scattered state of the display panel PNL. As explained with reference to FIG. 1, when voltage is applied to the liquid crystal layer LC, the light L1 entering the liquid crystal layer LC is scattered within the liquid crystal layer LC. The light L1 scattered by the liquid crystal layer LC is output from the display panel PNL. Such scattered light can be observed from the main surface 10A side as well as from the main surface 20B side. Further, in the scattered state, the background can be observed through the display panel PNL as that of the transparent state.

FIG. 4C is a diagram showing an example of the luminance distribution of the display panel PNL in the scattered state. The horizontal axis indicates the angle with respect to the normal N of the display panel PNL, and the vertical axis indicates the luminance. Note that as shown in FIG. 4B, the angle inclined toward the light-emitting element LD with respect to the normal N is defined as a negative angle (−θ), and the angle inclined toward a side away from the light-emitting element LD with respect to the normal N is defined as a positive angle (+0). In the luminance distribution of a portion of the light L1 traveling inside the display panel PNL, which is output by being scattered, from the display panel PNL, it can be confirmed that the luminance in a range of positive angles tends to be higher than that in a range of negative angles. Moreover, it can be confirmed that the luminance distribution does not have a peak at an angle of 0° (that is, in the direction of the normal N), but has a peak at an angle of about 70°.

FIG. 5 is a diagram illustrating the transparent state in the display device DSP of this embodiment. Note that the display panel PNL is illustrated in a simplified form. Here, the display panel PNL is in the transparent state, and therefore the background of the display panel can be observed through the display panel PNL regardless of whether it is observed from the main surface 10A side through the first prism P1 or from the main surface 20B side through the second prism P2.

Here, light L2 traveling from the first prism P1 toward the second prism P2 will be discussed. The light L2 traveling along the normal N of the display panel PNL enters the first prism P1 from the first bottom surface P13. The light L2 entering the first prism P1 is reflected by the first inclined surface P12 and then transmitted through the first surface P11. The light L2 transmitted through the first prism P1 is transmitted through the display panel PNL and enters the second prism P2 from the second surface P21. The light L2 entering the second prism P2 is reflected by the second inclined surface P22 and then transmitted through the second bottom surface P23. The first prisms P1 and the second prisms P2 are in contact with the air layer, and therefore the light entering or transmitted through each surface is refracted, but detailed illustrations are omitted here.

As explained with reference to FIG. 3, the first inclined surface P12 and the second inclined surface P22 are parallel to each other, and therefore optical paths of the light L2 transmitted through the first prisms P1 and the second prisms P2 are optically compensated. In other words, when a portion of the light L2 entering the first prism P1 at an incident angle θi with respect to the normal N is transmitted through the second prism P2 at a transmission angle θt with respect to the normal N, the incident angle θi is equal to the transmission angle θt. For example, when the incident angle θi is 0°, such a case corresponds to the case where the light L2 is incident from a direction parallel to the normal N. In this case, the transmission angle θt is also 0°. Similarly, as to the light traveling from the second prism P2 toward the first prism P1, the optical path is also optically compensated.

Therefore, in the case where the display panel PNL is in the transparent state, if it is observed from the main surface 10A side through the first prism P1 or from the main surface 20B side through the second prism P2, it can be observed in a normal way as in the case without the first prism P1 and the second prism P2.

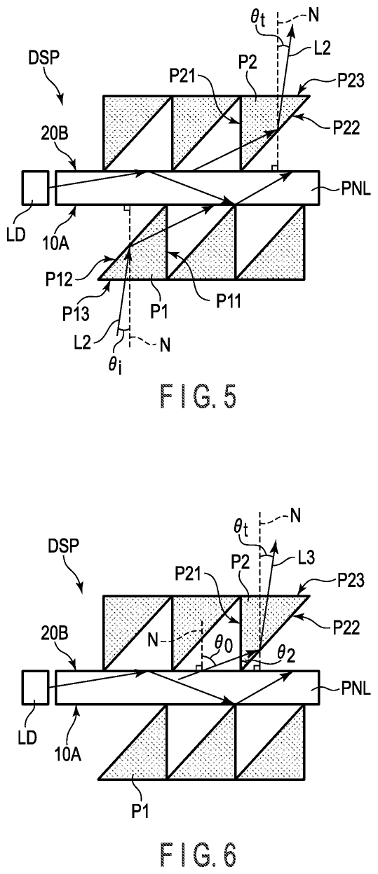

FIG. 6 is a diagram illustrating the scattered state in the display device DSP of this embodiment. Note that the display panel PNL is illustrated in a simplified form. Here, of the light scattered inside the display panel PNL, light L3 observed from the main surface 20B side will be focused.

The light L3 transmitted through the main surface 20B enters the second prism P2 from the second surface P21. The light L3 entering the second prism P2 is reflected by the second inclined surface P22 and then transmitted through the second bottom surface P23. When the light L3 transmitted through the main surface 20B of the display panel PNL at a transmission angle θ0 with respect to the normal N is transmitted through the second prism P2 at a transmission angle θt, the transmission angle θt is less than the transmission angle θ0. In other words, according to the display device DSP of this embodiment provided with the second prism P2, the luminance of the light transmitted in the direction of the normal line N increases as compared to the display device DSP of a comparative example without the second prism P2. Therefore, when the display device DSP is observed from the direction of the normal N, high-luminance images can be visually recognized.

In other words, when observing an image of the same luminance in the direction of normal N in the display device DSP of this embodiment, the luminance of the light-emitting elements LD can be reduced as compared to the display device DSP of the comparative example. Therefore, the power consumption can be reduced.

In this embodiment, by optimizing the second apical angle θ2 of the second prism P2, it is possible to design the display device DSP to have such a luminance distribution that a peak of luminance is in the direction of the normal N. Specific examples thereof will be provided below.

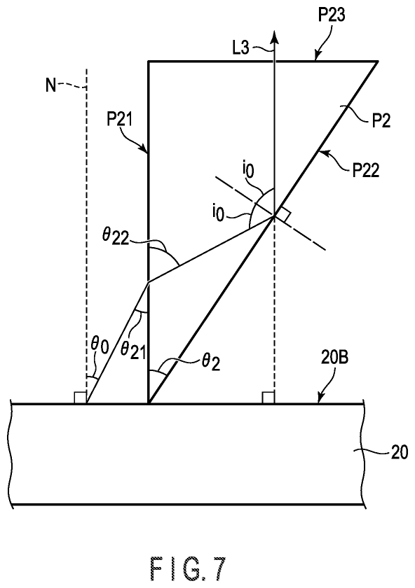

FIG. 7 is a diagram showing an example to illustrate an optimal angle of the second apical angle θ2. Here, it is assumed that light L3 transmitted through the main surface 20B of the second transparent substrate 20 at a transmission angle θ0 is transmitted through the second bottom surface P23 of the second prism P2 in a direction parallel to the normal N. The relationships among the angles θ0, θ2, θ21, θ22 and i0 shown in FIG. 7 will now be described. Note that the refractive index of the air layer is represented by n1, and the refractive index of the second prisms P2 is represented by n2.

The relationship between the angles θ0 and θ21 is as follows:

θ21=θ0 (1)

The relationship between the angles θ21 and 022 is as follows:

n1*sin(θ21)=n2*sin(θ22) (2)

The relationship between the angles θ2, θ22 and i0 is as follows:

θ22=θ2−i0+90° (3)

The relationship between the angles θ22 and i0 is as follows:

θ22+2*i0=180° (4)

Based on Equations (3) and (4), the relationship between the angles θ22 and i0 is as follows:

θ22=2*θ2 (5)

Based on Equations (1), (2) and (5), the relationship between the angles θ0 and θ2 is as follows:

n1*sin(θ0)=n2*sin(2*θ2) (6)

When the refractive index n1 is set to 1 and the refractive index n2 is set to 1.5, the second apical angle θ2 with respect to the transmission angle θ0 can be calculated based on equation (6) as follows.

When the transmission angle θ0 is 50°, the second apical angle θ2 is 15.4°.

When the transmission angle θ0 is 60°, the second apical angle θ2 is 17.6°.

When the transmission angle θ0 is 70°, the second apical angle θ2 is 19.4°.

When the transmission angle θ0 is 80°, the second apical angle θ2 is 20.5°.

As explained with reference to FIG. 4C, since the luminance distribution of the display panel PNL exhibits a peak in the vicinity of the transmission angle θ0 of 70°, it is preferable that the second apical angle θ2 be greater than 15°, less than 21°, and even more preferable that it should be 17.6° or greater but 20.5° or less. As described above, according to the display device DSP with the second apical angle θ2 thus set, its luminance distribution exhibits a luminance peak in the direction of the normal N.

Here, the second apical angle θ2 is described. But, as explained with reference to FIG. 3, the first apical angle θ1 is equivalent to the second apical angle θ2.

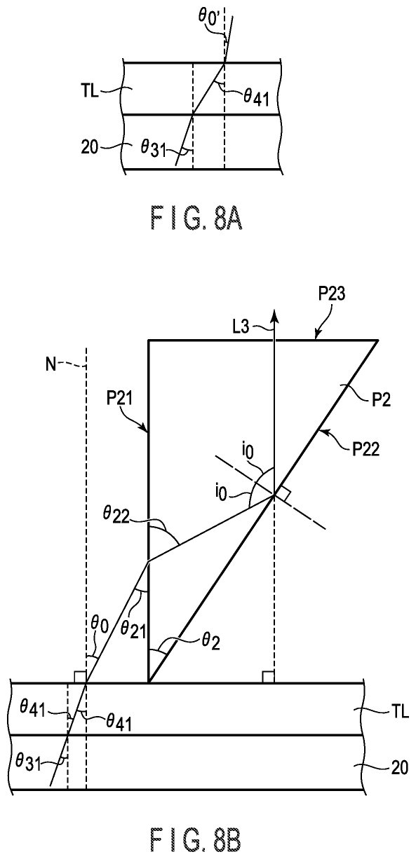

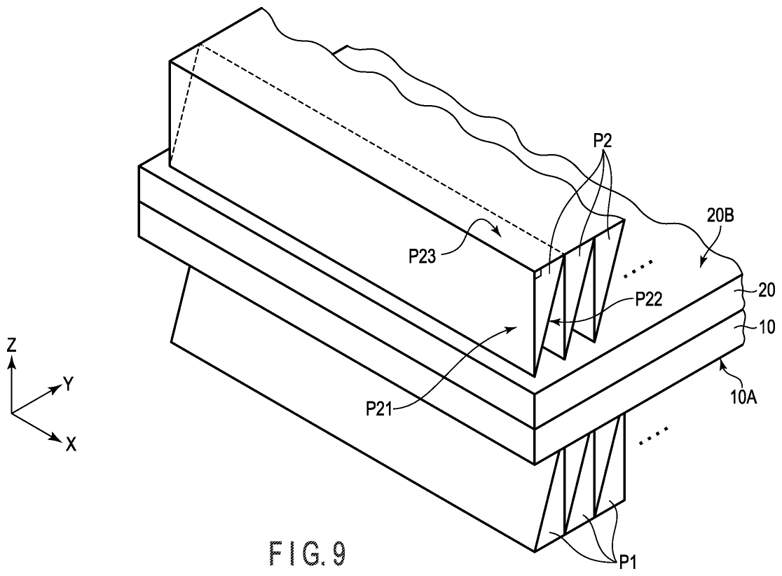

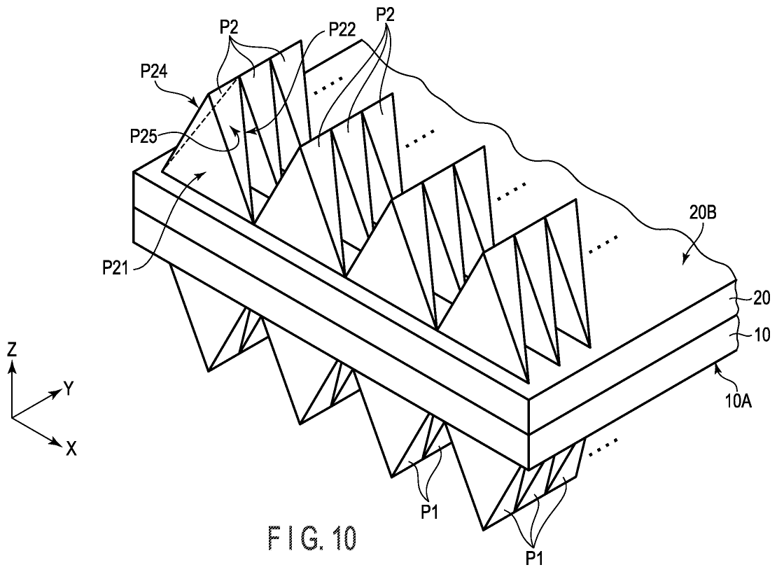

FIGS. 8A and 8A are diagrams showing another example to illustrate the optimal second apical angle 82. The example shown in FIGS. 8A and 8B is different from that shown in FIG. 7 in that a transparent layer TL is interposed between the second transparent substrate 20 and the second prism P2. The transparent layer TL is, for example, an adhesive layer that adheres the second prism P2 to the second transparent substrate 20.

As shown in FIG. 8A, light L4 transmitted through the second transparent substrate 20 and the transparent layer TL will be focused here. The relationships among angles θ0′, θ31, and θ41 are as below. Note here that the refractive index of the air layer is represented by n1, the refractive index of the second transparent substrate 20 is represented by n3, and the refractive index of the transparent layer TL is represented by n4.

n3*sin(θ31)=n4*sin(θ41)=n1*sin(θ0′) (7)

When the angle θ31 is the same as that of the example shown in FIG. 7, the angle θ0′ becomes equal to the angle θ0 shown in FIG. 7. Therefore, even when a transparent layer TL is interposed between the second transparent substrate 20 and the second prism P2 as shown in FIG. 8B, the optical path of the light L3 is substantially identical to that of the system shown in FIG. 7. Hence, the relationship in Equation (6) above is held true. In other words, the optimal second apical angle θ2 is the same as that of the example shown in FIG. 7.

Next, a configuration example of the first prisms P1 and the second prisms P2 that can be applied to the display device DSP of this embodiment will be explained.

FIG. 9 is a diagram showing a configuration example of the first prisms P1 and the second prisms P2. Each of the first prisms P1 and the second prisms P2 extends along the first direction X. The first prisms P1 are arranged in the second direction Y on the main surface 10A of the first transparent substrate 10.

The second prisms P2 are arranged in the second direction Y on the main surface 20B of the second transparent substrate 20. The first prisms P1 and the second prisms P2 have substantially the same shape.

Here, one of the second prisms P2 will be focused and its shape will be explained in more detail. That is, the second surface P21 is a rectangular surface parallel to the X-Z plane. The second bottom surface P23 is a rectangular surface parallel to the X-Y plane. The angle between the second surface P21 and the second bottom surface P23 is approximately 90°. The second inclined surface P22 is a rectangular surface that intersects the first direction X, the second direction Y and the third direction Z. The cross section of the second prism P2 in the Y-Z plane is a right triangle.

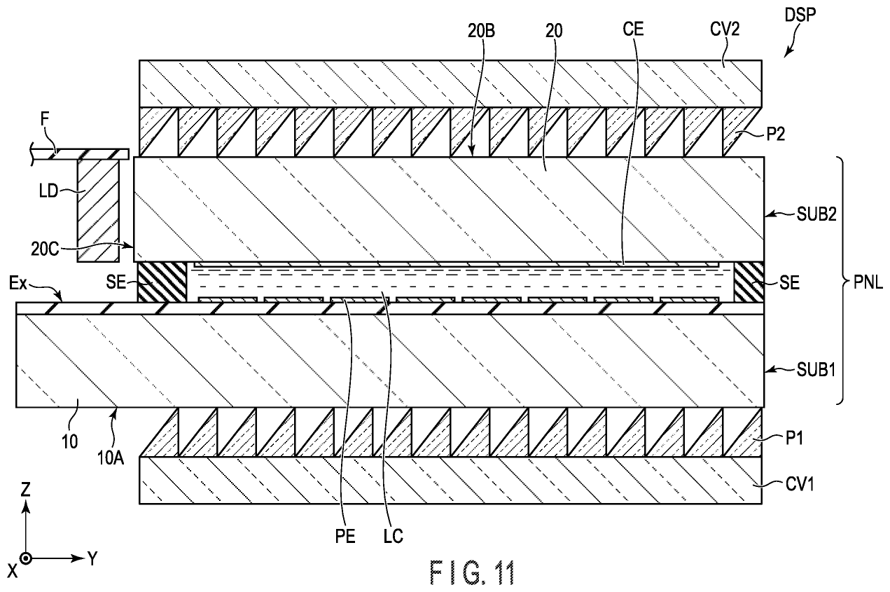

FIG. 10 is a diagram showing another configuration example of the first prisms P1 and the second prisms P2. The first prisms P1 are arranged in the first direction X and the second direction Y on the main surface 10A of the first transparent substrate 10. The second prisms P2 are arranged in the first direction X and the second direction Y on the main surface 20B of the second transparent substrate 20. The first prisms P1 and the second prisms P2 have substantially the same shape.

Here, one of the second prisms P2 will be focused and its shape will be explained in more detail. That is, the second surface P21 is a triangular surface parallel to the X-Z plane. The second inclined surface P22 is a triangular surface that intersects the first direction X, the second direction Y and the third direction Z. Between the second surface P21 and the second inclined surface P22, two triangular surfaces P24 and P25 are formed. The cross section of the second prism P2 in the Y-Z plane is a right triangle.

### Second Configuration Example

FIG. 11 is a cross-sectional view showing the second configuration example of the display device DSP of this embodiment. The second configuration example shown in FIG. 11 is different from the first configuration example shown in FIG. 3 in that a first cover member CV1 and a second cover member CV2 are provided to cover the first prisms P1 and the second prisms P2, respectively. The first cover member CV1 and the second cover member CV2 are transparent base materials such as glass substrates or plastic substrates. The first prisms P1 are provided between the first transparent substrate 10 and the first cover member CV1. The second prisms P2 are provided between the second transparent substrate 20 and the second cover member CV2. To the first prisms P1 and the second prisms P2, any of the configuration examples in FIGS. 9 and 10 can be applied.

In this second configuration example, an advantageous effect similar to that of the first configuration example can be obtained. In addition, the first prisms P1 and the second prisms P2 can be protected.

### Third Configuration Example

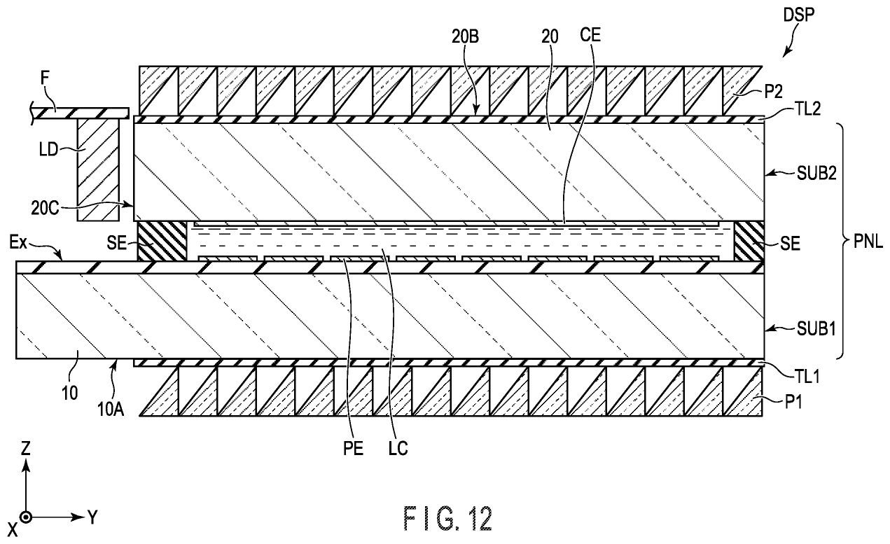

FIG. 12 is a cross-sectional view showing the third configuration example of the display device DSP of this embodiment. The third configuration example shown in FIG. 12 is different from the first configuration example shown in FIG. 3 in that a first transparent adhesive layer TL1 is provided to adhere the first transparent substrate 10 and the first prisms P1, and a second transparent adhesive layer TL2 is provided to adhere the second transparent substrate 20 and the second prisms P2. The optimum second apical angle θ2 for the case where the first transparent adhesive layer TL1 and the second transparent adhesive layer TL2 are provided is as explained with reference to FIGS. 8A and 8B. To the first prisms P1 and the second prisms P2, any of the configuration examples in FIGS. 9 and 10 can be applied.

In the third configuration example as well, an advantageous effect similar to that of the first configuration example is obtained.

As described above, according to the present embodiments, a display device which can reduce the power consumption can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

An example of the display device obtained from the configuration disclosed herein will be provided as additional notes.

(1) A display device comprising:

a plurality of first prisms;

a plurality of second prisms; and

a display panel provided between the first prisms and the second prisms,

the display panel comprising:

a first substrate comprising a first transparent substrate and a pixel electrode,

a second substrate comprising a second transparent substrate and a common electrode opposing the pixel electrode, and

a liquid crystal layer provided between the first substrate and the second substrate and containing a polymer and liquid crystal molecules.

(2) The display device of item (1), wherein

each of the first prisms comprises a first apex opposing the first transparent substrate, and

each of the second prisms comprises a second apex opposing the second transparent substrate.

(3) The display device of item (2), wherein

the first apex has a first apical angle, and

the second apex has a second apical angle equivalent to the first apical angle.

(4) The display device of item (3), wherein

the first apical angle and the second apical angle are greater than 15° but less than 21°.

(5) The display device of item (2), wherein

each of the first prisms comprises a first surface substantially perpendicular to the first transparent substrate and a first inclined surface inclined with respect to the first transparent substrate, and the first surface and the first inclined surface form the first apex,

each of the second prisms comprises a second surface substantially perpendicular to the second transparent substrate and a second inclined surface inclined with respect to the second transparent substrate, and the second surface and the second inclined surface form the second apex, and

the first inclined surface is substantially parallel to the second inclined surface.

(6) The display device of any one of items (1) to (5), wherein

the first prisms extend in a first direction and are arranged in a second direction intersecting the first direction, and

the second prisms extend in the first direction and are arranged in the second direction.

(7) The display device of any one of items (1) to (5), wherein

the first prisms are arranged in a first direction and a second direction intersecting the first direction, and

the second prisms are arranged in the first direction and the second direction.

(8) The display device of any one of items (1) to (7), further comprising:

a first cover member which covers the first prisms, and

a second cover member which covers the second prisms.

(9) The display device of any one of items (1) to (7), further comprising:

a first transparent adhesive layer which adheres the first transparent substrate and the first prisms, and

a second transparent adhesive layer which adheres the second transparent substrate and the second prisms.

(10) The display device of any one of items (1) to (9), further comprising:

a light-emitting element,

wherein

the second transparent substrate comprises a side surface opposing the light-emitting element.

What is claimed is:

1. A display device comprising:
a plurality of first prisms;
a plurality of second prisms; and
a display panel provided between the first prisms and the second prisms,
the display panel comprising:
a first substrate comprising a first transparent substrate and a pixel electrode,
a second substrate comprising a second transparent substrate and a common electrode opposing the pixel electrode, and
a liquid crystal layer provided between the first substrate and the second substrate and containing a polymer and liquid crystal molecules.

2. The display device of claim 1, wherein
each of the first prisms comprises a first apex opposing the first transparent substrate, and
each of the second prisms comprises a second apex opposing the second transparent substrate.

3. The display device of claim 2, wherein
the first apex has a first apical angle, and
the second apex has a second apical angle equivalent to the first apical angle.

4. The display device of claim 3, wherein
the first apical angle and the second apical angle are greater than 15° but less than 21°.

5. The display device of claim 2, wherein
each of the first prisms comprises a first surface substantially perpendicular to the first transparent substrate and a first inclined surface inclined with respect to the first transparent substrate, and the first surface and the first inclined surface form the first apex,
each of the second prisms comprises a second surface substantially perpendicular to the second transparent substrate and a second inclined surface inclined with respect to the second transparent substrate, and the second surface and the second inclined surface form the second apex, and
the first inclined surface is substantially parallel to the second inclined surface.

6. The display device of claim 1, wherein
the first prisms extend in a first direction and are arranged in a second direction intersecting the first direction, and
the second prisms extend in the first direction and are arranged in the second direction.

7. The display device of claim 1, wherein
the first prisms are arranged in a first direction and a second direction intersecting the first direction, and
the second prisms are arranged in the first direction and the second direction.

8. The display device of claim 1, further comprising:
a first cover member which covers the first prisms, and
a second cover member which covers the second prisms.

9. The display device of claim 1, further comprising:
a first transparent adhesive layer which adheres the first transparent substrate and the first prisms, and
a second transparent adhesive layer which adheres the second transparent substrate and the second prisms.

10. The display device of claim 1, further comprising:
a light-emitting element,
wherein the second transparent substrate comprises a side surface opposing the light-emitting element.

11. The display device of claim 1, further comprising:
a light-emitting element,
wherein
in the first prism, the first inclined surface is closer to the light-emitting element than from the first surface, and
in the second prism, the second surface is closer to the light-emitting element than from the second inclined surface.

12. The display device of claim 6, wherein
a space between each adjacent pair of first prisms and a space between each adjacent pair of second prisms are air layers.
